(19) United States
(12) Patent Application Publication
(10) Pub. No.: US 2003/0036987 A1
(43) Pub. Date: Feb. 20, 2003

(54) Method and system for handling escrow arrangements

(76) Inventor: Kenji Omiya, Tokyo (JP)

Correspondence Address: HOGAN & HARTSON L.L.P., 500 S. GRAND AVENUE, SUITE 1900, LOS ANGELES, CA, 90071-2611, US

(21) Appl. No.: 09/929,199

(22) Filed: Aug. 15, 2001

(51) Int. Cl. G06F 17/60

(52) U.S. Cl. 705/35

(57) ABSTRACT

A method and system are provided for supplying information to users about each stage of a multi-stage project before dispensing funds. The method includes inputting a set of terms for dispensing funds for each stage of a multi-stage project. Data is recorded related to the terms for dispensing funds. Funds are dispensed after the completion of each stage of the multi-stage project, wherein completion of each stage is dependent upon viewing and approving each stage of the multi-stage project.

### BACKGROUND OF THE INVENTION

1) Field of the Invention

The present invention relates to a method and system for electronic commerce network applications, and more particularly, to a method and system for supplying information to users about each stage of a multi-stage project before an escrow payment is made over an electronic interconnected network.

2) Related Art

The so-called E-commerce (electronic commerce) has been exploding ever since the inception of the hugely popular Internet. The Internet is an interconnected network that is accessible to anyone who has a computer or a communication device, such as a Palm Pilot from 3-Com, Inc., configured to connect to the Internet. Basically, E-commerce means doing business in electronic forms, e.g., exchanging electronic data over a computer network such as the Internet, a Wide Area Network (WAN), or a Local Area Network (LAN). By its nature, the Internet offers a user access to a virtually unlimited informational world provided to the public by persons who establish web sites or web pages communicatively linked to the Internet. Thus, the Internet allows business entities to conduct business over the Internet in almost any creative way. The Internet has been so successful and so widely accepted with the general public that E-commerce for businesses across the world is increasing at an exponential rate each year.

“The Internet” is generally referred to as a vast number of computers or communication devices interconnected through communication links, such as telephone lines, or through wired or wireless networks, such as the wide area network. There are several protocol agreements in place applicable to the Internet so that each interconnected computer or communication device may exchange electronic information with another through the Internet. Applying these protocols to their hardware/software configurations, many Internet service providers or vendors offer various Internet services to the public with or without a fee. The services may include, without limitation, electronic mail, Gopher, or World Wide Web (WWW) access. Aside from email service, the WWW is probably the most prevalent form of the Internet service to the public.

The WWW is a standard protocol allowing web documents, which may contain graphic images text, sound, video, or any combination thereof, to be transferred through the Internet. Generally, a remote server system of the vendor maintains a web side on the WWW. The vendor's web site may contain many web pages or hierarchies of web pages accessible to the public with or without limitation. Each web page is typically defined as an HTML document using the HyperText Markup Language (HTML) to describe contents of the web document. Upon receiving an HTML document from the Internet, the user/surfer of the Internet will need a browser at a local host, e.g., a local computer or communication device at the user end, to translate the HTML document into a viewable form to the user. Currently, there are many commercial browsers available to the public. One popular browser is Netscape Navigator. “Netscape Navigator” is a trademark of the Netscape Communications Corporation.

To surf the Internet, the user will specify to the browser a web address of the web site he/she wishes to view in a request (a HyperText Transfer Protocol (HTTP) request) to the Internet. The HTTP is another Internet protocol to transfer a web document from a predetermined Internet address to another. The web addresses of all web sites are defined under a Uniform Resource Protocol (URL). The user's HTTP request is then forwarded to the remote server system which, in response to the request, send a web page (an HTML document) to the local host through the Internet. Upon receiving the HTML document, the browser displays the web page as defined by the HTML in a user viewable way.

As mentioned, the Internet provides users access to an unlimited amount of information. Moreover, the Internet is particularly conducive to conducting business (E-commerce) by virtue of its borderless nature. Namely, the local user (customer) may order a product or subscribe to a service on the Internet from the remote vendor simply by clicking or typing on the local host. The customer need not personally go to the shop of the vendor to conduct the transaction. As long as the remote vendor's computer or server's power is on and ready to take orders, there is essentially no limitation as to time and location for customers or prospective customers to do the shopping. Consequently, individuals may now transact business over the Internet at anytime from anywhere in the world.

Although the Internet greatly facilitates business transactions across geographic borders, many limitations or inconveniences still exist on the Internet when doing business online.

In particular, in the construction industry, the use of the Internet has been limited in assisting buyers, intermediaries such as banks and sellers during the various stages in completing a project. In general, a buyer makes an agreement with a contractor to have a project such as a house, for example, to be constructed. The buyer also obtains financing from a lending institution such as a bank. The money that is loaned to the buyer is usually placed in escrow until various stages of the project have been completed. To date, buyers have been limited in their ability to review in person the completion of each stage of the project before an escrow payment has been made. For example, the completion of a first stage of a construction project such as laying a foundation, is checked by an inspector and the results are reported to the contractor. Afterwards, the contractor notifies the buyer by fax or by a telephone call that the foundation has passed or failed inspection. However, this notification may not be acceptable to the buyer because the buyer may have wanted to inspect the foundation for himself. However, due to scheduling conflicts between the buyer, the contractor and inspector, it is almost impossible for the buyer to see each stage of the project before and/or after it been completed and inspected. Yet, the buyer is still responsible for making payments from the escrow account even if he is not completely satisfied with the work performed.

Moreover, it is also inconvenient and time consuming for the contractor to inform the buyer of each and every step of the building process. Further it is difficult to describe over the telephone or communicate in writing how something looks. Although the contractor could send the buyer pictures of each stage of the building project, this is also time consuming and expensive.

It would therefore be an advantage to provide a method and system for supplying information to users about each stage of a multi-stage project before an escrow payment is made.

### SUMMARY OF THE INVENTION

A method and system are provided for supplying information to users about each stage of a multi-stage project before dispensing funds. The method includes inputting a set of terms for dispensing funds for each stage of a multi-stage project. Data is recorded related to the terms for dispensing funds. Funds are dispensed after the completion of each stage of the multi-stage project, wherein completion of each stage is dependent upon viewing and approving each stage of the multi-stage project.

The above-stated advantages are for illustrative purposes and, thus, are non-limitative to the scope of the present invention. Additional features and advantages of the present invention will be set forth in the descriptions that follow and in part will be apparent from the description, or may be learned by practice of the present invention. The advantages of the invention will be realized and attained by the structure particularly pointed out in the written description and claims hereof as well as the appended drawings. It will be further understood that the drawings are for purposes of illustration and are not to be construed as defining the scope and limits of the invention, reference being had for the latter purpose to the claims appended hereto.

### BRIEF DESCRIPTION OF THE DRAWINGS

FIG. 1 is a flow chart illustrating procedures for decision-making according to one embodiment of the present invention.

FIG. 2 is a block diagram showing a Project Number and Manager Table according to one embodiment of the present invention.

FIG. 3 is a block diagram showing a Task Table according to one embodiment of the present invention.

FIG. 4 is a block diagram showing a Task Information Table according to one embodiment of the present invention.

FIG. 5 is a schematic view illustrating the interconnected relationship of some components according to one embodiment of the present invention.

FIG. 6 is a schematic view illustrating an image retrieval system according to one embodiment of the present invention.

### PREFERRED EMBODIMENTS OF THE PRESENT INVENTION

A method and system are provided for supplying information to users about each stage of a multi-stage project before dispensing funds. The method includes inputting a set of terms for dispensing funds for each stage of a multi-stage project. Data is recorded related to the terms for dispensing funds. Funds are dispensed after the completion of each stage of the multi-stage project, wherein completion of each stage is dependent upon viewing and approving each stage of the multi-stage project.

For purposes of description, the term “building project” will be used to refer to any multi-stage project where escrow payments are made after the completion of each stage of the multi-stage project. However, the teachings herein can be applied to any type of project and the term building project is therefore for descriptive purposes only and is not intended in any way to limit the scope of the invention claimed herein. The term “buyer” will be used to refer to anyone contracting to have a multi-stage project constructed. The term “intermediaries” refers to any lending institution personal that disperses funds after the completion of a stage in a multi-stage project. The term “seller” refers to anyone that oversees the project being constructed such as construction manager, subcontractor, inspector, etc. The term “user” refers to the seller, buyer, intermediaries or other persons involved in the multi-stage project.

Any and all hardware configurations of the present invention can be implemented by one skilled in the art using well known hardware components. In the presently preferred embodiment, the present invention is implemented using at least one computer. Such computer can include but is not limited to a personal computer, network computer, network server computer, dumb terminal, personal digital assistant, work station, minicomputer, a mobile Internet device such as a cell phone, and a mainframe computer, as well as one or more computers that are linked together in a network such as a local area network, or wide area network. For example, the compiling of project information can be implemented as one or more software applications, software modules, firmware such as a programmable ROM or EEPROM, hardware such as an application-specific integrated circuit (“ASIC”) or any combination of the above.

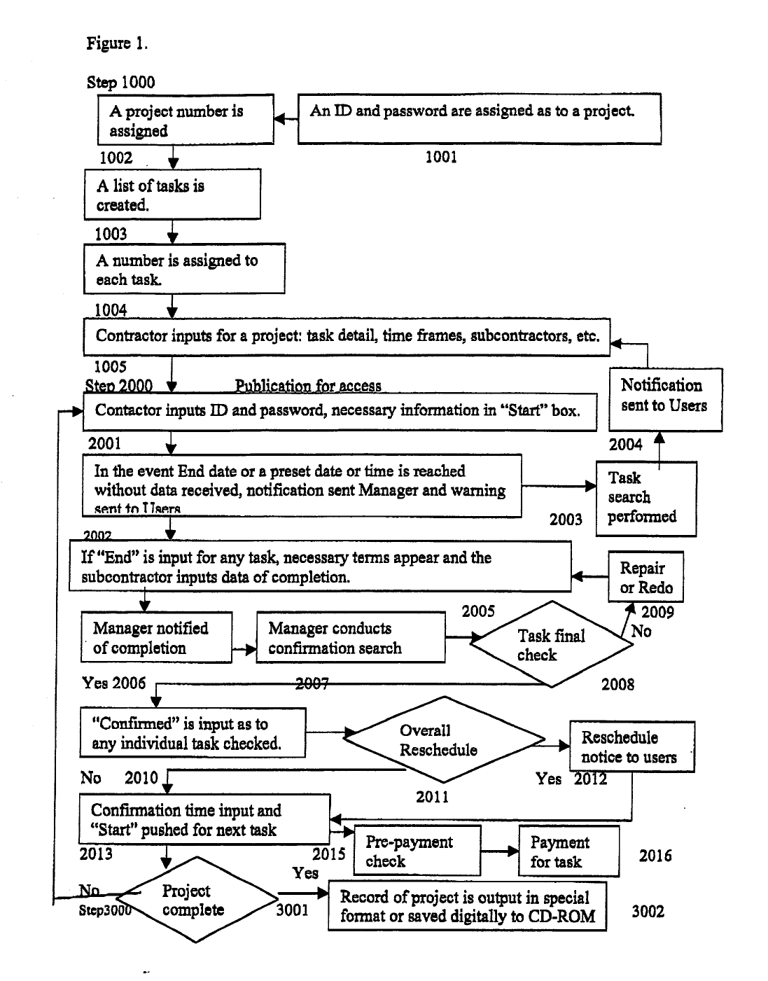

FIG. 1 shows a flow chart illustrating the procedures according to one embodiment of the present invention. At step 1000 in FIG. 1, a construction project is prepared for listing via a communications interconnected network.

At step 1001 user identification (ID)s and passwords are assigned to the construction project. The user IDs and passwords are assigned to users in the construction project such as the buyer(s), contractor(s), manager(s), subcontractor(s) any payment related person including but not limited to credit company or bank employee(s), or other persons involving in the building project.

At step 1002 a number is assigned to the construction project. With the information received in steps 1001 and 1002, the user IDs and passwords and construction project number, respectively, a listing such as table 110 (“Project Number and Manager Table”) can be created.

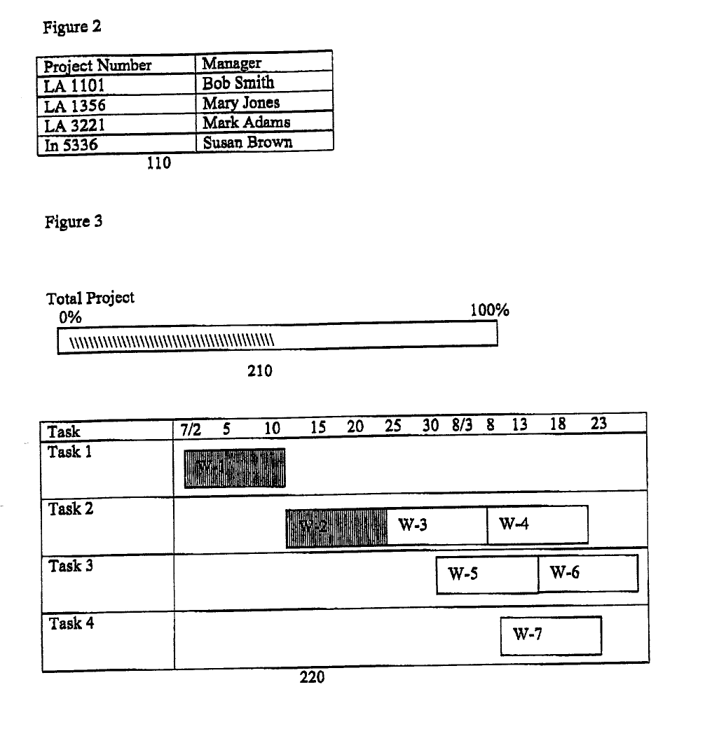

As shown in FIG. 2, table 110 includes a column with the heading Project Number for the assigned construction project number and a column with the heading Manager for the person overseeing the construction project. Table 110 also includes four project numbers with each project number designated by two letters followed by four digits. As one skilled in the art would appreciate, the present invention is not limited to the combination of two letters and four digits to represent the construction project. Any such combination of letters, numbers or symbols can be used for the construction project number without departing from the spirit and scope of the present invention. Across from each of the construction project numbers is the name of the person in charge of the project such as a contractor or manager.

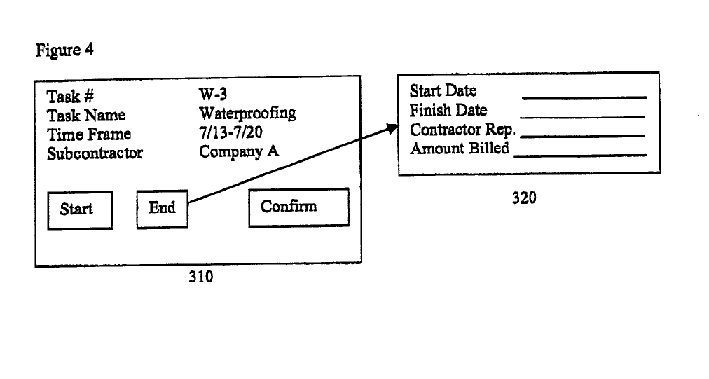

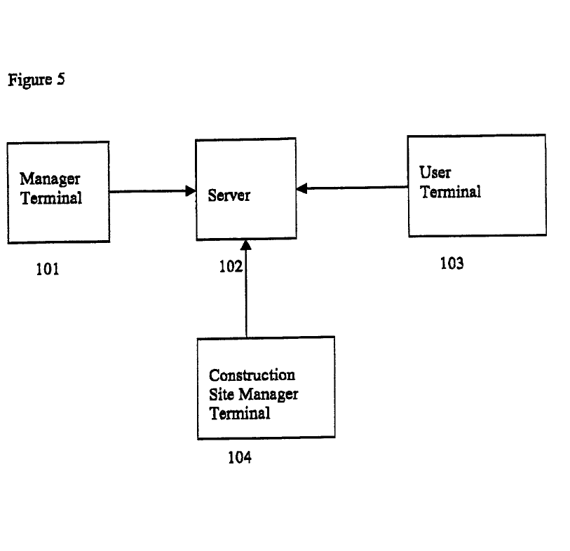

At step 1003, a list of tasks is created relating to completion of the construction project. In step 1004 a number is assigned to each task. For example, as shown in FIGS. 3 and 4 one task is assigned the number W-3.

At step 1005, a manager inputs the details of each task, time frames, names of subcontractors and other useful information that would be beneficial to the buyer or the bank or other persons associated with the construction project.

At step 2000, the process for monitoring the construction project and task completion, modification and dispersal begins. At step 2001, a manager or other authorized user is prompted to input their ID and password. If the user inputs a password or ID unrecognizable by the system, the system will again request the user to renter a correct ID and password. It the user fails several times in entering a recognizable ID and password, the system may discontinue and direct the user to obtain a correct password. If the user inputs a password and ID recognizable to the system, the system allows the user to input other information to start a task by clicking on an icon representing a particular task such as “W-3”. Those skilled in the art are aware that the ability to access or input data to a particular table such as table 220 can be limited to certain ID's and passwords, and thereby certain users. By way of example only, in an embodiment of the present invention, the present invention can be preset in such a way that only the manager and users providing fees to the escrow account can confirm a building project. In this way, IDs or passwords other than those of the manager and user can be blocked from access to the “confirm” icon. The reason is that by presetting the number of accessing users, the manager may confirm the completion of a particular task prior to dispersing funds to the person performing or to be paid in relation to the task. Additionally, the manager may wish to confirm the approval of the buyer prior to dispersing such funds. Pre-payment conditions are preset during the initial input of data relating to a project or task so that an escrow type function with any requirements agreeable initially to the users becomes possible. Funds may be distributed in step 2016, following confirmation of any pre-payment conditions in step 2015. The buyer may also want to be apprised of the progress in the project or task and require their consent prior to any funds being released from escrow. Upon clicking on an icon, an image may appear to show information related to the task such as shown in FIG. 4, image 310. Included with image 310 could be icons for “Start”, “End” and “Confirm”. Clicking on these icons would result in an image appearing similar to image 320 into which information related to starting, ending or confirming a task can be input.

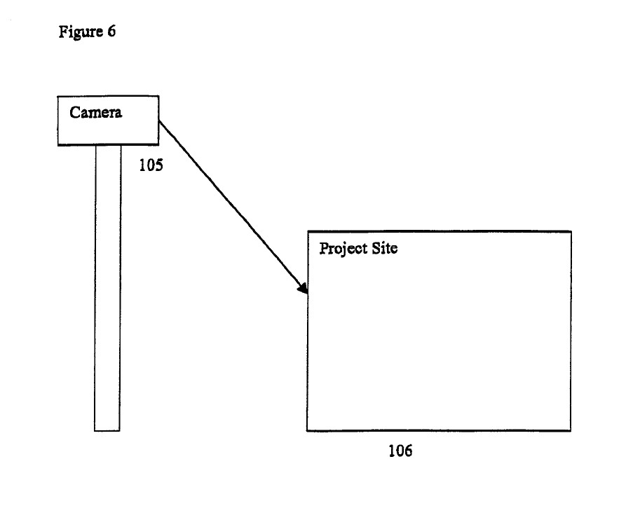

As shown in FIG. 6, a camera 105 can be installed near the project site 106 so that pictures of the progress of the project can be recorded. Camera 105 can comprise any digital camera or other device capable of generating an image and connecting with a communication network such as the Internet. At any point in a task, authorized users may view the progress of the project by accessing the camera through a communication network. As an additional feature of an embodiment of the present invention, the focus or angle of the camera could be controlled by the user accessing the system at that time. In this manner, all users can are informed of the progress on the project and possibly alleviate any concern that they have relating to the status of the project. In a similar manner the manager could have photographs taken of each confirmed task to generate evidence of confirmation and completion. In step 2002, notification is sent to users if a time limit for a task is reached without “End” being registered. This serves as a mechanism for reminding the person performing the task that they should be finished and alerting other users of any delays that may change the schedule of the project's remaining tasks. In step 2005, a subcontractor carrying out a task can input required data as to a task according to preset data requirements of the buyer or other users, as appropriate, such as a bank employee, manager or other person responsible for escrow related payments. The manager is also notified in step 2006 of any “End” being properly registered under step 2005, so that they will then conduct a confirmation search in step 2007. The confirmation search may include use of camera 105, review of data as appearing in FIGS. 2, 3 and 4 or any other steps that the manager deems appropriate to take as part of the confirmation process including, but not being limited to, contacting a surveyor or other person to confirm completion and evaluation of results, contacting any user by wired, wireless or other communication means. In step 2008, a final check is also allowed for the manager or other user to confirm completion of a task. If such confirmation is not granted by the manager's entry of “Confirmation” an icon or word form as appropriate, step 2009 automatically intervene in which the unsatisfied terms may be reset and the subcontractor may be contacted, informing them that the task is not complete, completion of the task is required and the input of proper relevant data necessary. If completion is confirmed and “Confirmation” is input according to step 2010, the confirmation time is then input automatically or by the manager. “Start” is then input using words or an icon as appears in FIG. 4 to start the next task. Step 2015 is then initialed automatically as to the task to determine if payment is merited. If all tasks are completed, then step 3001 will automatically be succeeded by step 3002 in which recording occurs as to the project as described below. If all tasks are not completed, step 2001 will be reactivated as to the next task.

As shown in FIG. 3, the timeframe for the entire project is preset, based upon the cumulative time required for all tasks to be completed, allowing for coextensive time periods or preset as one entire time period upon which the entire project should conclude, if on time. As tasks are completed, the total project scale indicates what percentage of the project is completed as shown in table 210. In one embodiment, each tasks can be weighted equally in evaluating the percentage of completion, whereby, by way of example only, six tasks are required and registration of the completion of each of the six tasks will result in the total project percentage completed being increased by one-sixth or one hundred percent for each task completed. Alternatively, time can be used to measure the percentage of completion of the project, with the timing being automatically reset whenever a time extension is required.

Referring now to FIG. 5, one embodiment of a system for carrying out the method of the present invention is shown. The system includes a server 102, and terminals 101, 103, and 104. Server 102 can be a host server and includes any commercial server, computer or other device with access to a memory and capable of connection with and use of a communications network. Server 102 is able to record on command or periodically to a memory, the digital contents registered and controlled by it, including, but not limited to, digital images of the project site 106, the tasks and project related information (“Recordable Data”). Host server 102 also complies Recordable data into a plurality of tables as discussed above. The tables are compiled periodically when a task has been completed or if the status of the building project changes. After a table has been compiled, preferably by software, host server 102 stores them in memory. Alternatively, host server 102 routes the compiled tables over an Ethernet connection for example, to another server for retrieval by users.

Host server 102 communicates with terminals 101, 103 and 104, all of which respectively include devices capable of communication via either a wired or wireless communication network. In one example, host server 102 communicates with terminals 101, 103 and 104 via the Internet. Host server 102 is operable with the World Wide Web (WWW). A user at user terminal 103 can then gain access to the tables from host server 102 over a wide area network connection or a local area network connection via a WWW browser. The tables can be printed at terminals 101, 103 and 104 as hard copies.

To access the tables, a user at either terminal 101, 103 or 104 starts the WWW browser and enters a given uniform resource locator (URL) to obtain a WWW page. The WWW page includes a user ID and password input box. The user enters a user ID and a password and then clicks a designated icon to gain access to the tables.

The terminals 101, 103 and 104 include, but are not limited to, computers, personal computers, enabled cellular phones, palm computers and other similar devices. Terminals 101, 103 and 104 are used variously by users that communicate solely with server 102 without any need to communicate with each other directly. By way of example only, terminal 101 is labeled “Manager Terminal”, terminal 103 is labeled “User Terminal” and terminal 104 is labeled “Construction Site Manager Terminal” to demonstrate one possible arrangement of users according to a one embodiment of the present invention.

Upon completion of a building project, server 102 prints out or saves a copy of Recordable Data of the building project. Recordable Data may also be saved to a CD-ROM by server 102 and stored at any appropriate facility or sent by e-mail or other communication means to users so requesting. As desired, according to another embodiment of the present invention, the same recording as carried out in step 3002 could be carried out as to any individual task when completed. In general, a copy of the Recordable Data is stored by the controller of server 102. Thus, a record of the entire project is kept for any later escrow related disputes as to work performed.

While the invention is described in conjunction with the preferred embodiments, this description is not intended in any way as a limitation to the scope of the invention. Modifications, changes and variations which are apparent to those skilled in the art can be made in the arrangement, operation and details of the construction of the invention disclosed herein without departing from the spirit and scope of the invention.

What is claimed is:

1. A method for supplying information to users about each stage of a multi-stage project before dispensing funds comprising the steps of:
inputting a set of terms for dispensing funds for each stage of a multi-stage project;
recording data related to the terms for dispensing funds; and
dispensing funds after the completion of each stage of the multi-stage project;
wherein completion of each stage is dependent upon viewing and approving each stage of the multi-stage project.

2. The method according to claim 1, wherein the step of inputting the set of terms for dispensing funds comprises the step of entering a completion date for each of the stages of the multi-stage project.

3. The method according to claim 1 further comprising the step of assigning a number to the multi-stage project.

4. The method according to claim 1 further comprising the step of entering a user ID and password.

5. The method according to claim 3, wherein the step of recording data comprises the step of listing the multi-stage project number and a manager responsible for the multi-stage project.

6. The method according to claim 1 further comprising the steps of:
generating a chart listing multi-stage project data;
distributing the chart over a communication network;
assigning an identification and password for approved persons related to the multi-stage project;
generating a timeline image relating to the multi-stage project; and
allowing the approved persons access to the timeline.

7. The method according to claim 6 further comprising:
generating a task box related to the multi-stage project with icons for starting, ending and confirming a task; and
designating which of the approved persons is responsible for starting, ending and confirming the task.

8. The method according to claim 7 further comprising the step of sending a message to any approved person that is designated to be notified of the starting, ending or confirming of the task.

9. The method according to claim 7 further comprising the step of allowing the approved user to access images of the multi-stage project by accessing an imaging device located near a construction site of the multi-stage project.

10. The method according to claim 1 further comprising the step of storing the data in memory.

11. A system for supplying information to users about each stage of a multi-stage project before dispensing funds comprising:
an interconnected network adapted to transmit electronic data;
at least one communicative device coupled to the interconnected network, the communicative device being capable of inputting a set of terms for dispensing funds for each stage of a multi-stage project and recording data related to the terms for dispensing funds; and
a computing device coupled to the interconnected network, the computing device maintaining an interactive site accessible by the at least one communicative device via the interconnected network, the computing device being capable of dispensing funds after the completion of each stage of the multi-stage project;
wherein completion of each stage is dependent upon viewing and approving each stage of the multi-stage project.

12. The system according to claim 11, wherein the interconnected network comprises the Internet.

13. The system according to claim 11, wherein the interconnected network comprises a wide area network.

14. The system according to claim 11, wherein the interconnected network comprises a local area network.

15. The system according to claim 11, wherein the at least one communicative device is a user computer capable of inputting data.

16. The system according to claim 11, wherein the computing device is a host server capable of storing data and maintaining the interactive site.

17. The system according to claim 11 further comprising a camera to provide images of each stage of the multi-stage project.

18. The system according to claim 11 further comprising another communicative device coupled to the interconnected network and capable of confirming and modifying the terms for dispensing funds.

19. The system according to claim 11 further comprising a display device to display the set of terms for dispensing funds for each stage of a multi-stage project.

20. A computer program, stored on a computer-readable medium, for supplying information to users about each stage of a multi-stage project before dispensing funds, the computer program comprising instructions for causing a computer system to:
receive a set of terms for dispensing funds for each stage of a multi-stage project;
record data related to the terms for dispensing funds; and
dispense funds after the completion of each stage of the multi-stage project;
wherein completion of each stage is dependent upon viewing and approving each stage of the multi-stage project.
